(19) United States
(12) Patent Application Publication
(10) Pub. No.: US 2026/0156585 A1
(43) Pub. Date: Jun. 4, 2026

(54) ELECTRONIC DEVICE

(71) Applicant: Samsung Electronics Co., Ltd., Suwon-si (KR)

(72) Inventors: Byeongtak JO, Suwon-si (KR); Gangminh LEE, Suwon-si (KR); Dujeong LEE, Suwon-si (KR); Jonghwan LEE, Suwon-si (KR); Kyunam CHO, Suwon-si (KR)

(21) Appl. No.: 19/307,452

(22) Filed: Aug. 22, 2025

(30) Foreign Application Priority Data
Dec. 4, 2024 (KR) 10-2024-0178602

(51) Int. Cl. H04W 52/36; H04W 52/22; H04W 84/12

(52) U.S. Cl. CPC H04W 52/367; H04W 52/225; H04W 84/12

(57) ABSTRACT

An electronic device includes an application processor, and at least one communication processor that generates first specific absorption rate information associated with electromagnetic waves according to a first wireless communication method, and second specific absorption rate information associated with electromagnetic waves according to a second wireless communication method. The application processor receives the first specific absorption rate information and the second specific absorption rate information, generates integrated specific absorption rate information based on one or both of the first specific absorption rate information or the second specific absorption rate information, determines whether to adjust a transmission power of the first wireless communication method or the second wireless communication method, and transmits a transmission power control request to the at least one communication processor to adjust one or both of the transmission power of the first wireless communication method or the transmission power of the second wireless communication method.

### CROSS-REFERENCE TO RELATED APPLICATION

This application claims priority to Korean Patent Application No. 10-2024-0178602, filed in the Korean Intellectual Property Office on Dec. 4, 2024, the entire contents of which are hereby incorporated by reference.

### BACKGROUND

### Field

The present disclosure relates to an electronic device, and more particularly, to an electronic device that integrally manages specific absorption rates according to various Near-Field Communication methods.

### Description of Related Art

An electronic device (e.g., a user equipment (UE)) for supporting a wireless communication may radiate electromagnetic waves (e.g., wireless communication signals). The electromagnetic waves may cause harm to the human body, for example, when the electronic device is in closer proximity to the human body. Due to the possibility of the electromagnetic waves causing harm, numerous countries and international organizations stipulate regulations that limit the amount of electromagnetic waves radiated from electronic devices to a certain level.

A specific absorption rate (SAR) denotes the amount of electromagnetic waves radiated from electronic devices and absorbed into the human body, and electronic devices may be designed not to exceed a specific limit of electromagnetic waves.

The electronic device provides various types of communication methods including wireless communication. For example, examples of Near Field Communication include wireless local area network (WLAN, e.g., Wi-Fi), Bluetooth, and ultra-wideband (UWB), etc. According to prior art, electronic devices are designed to allocate a specific absorption rate budget for each wireless communication method, so that the electromagnetic waves that occur in each wireless communication method may not exceed a predetermined threshold. However, since some of the wireless communication methods may not reach the predetermined threshold, the specific absorption rate budget may not be fully used. Specifically, when a wireless communication method operates with a significantly low power, or fails to operate during a specific time section, the allocated specific absorption rate budget may be ineffectively used.

The above-described information is only to improve the understanding of the background of the present disclosure, but may include information that is not relevant to the conventional technology.

### SUMMARY

The present disclosure is aimed to provide an electronic device to solve the above-described problems.

The problem to be solved is not limited the above, but the other tasks not mentioned above may be explicitly known to those skilled in the art from the description of the present disclosure below.

According to embodiments of the present disclosure, there is provided an electronic device including an application processor, and at least one communication processor configured to generate first specific absorption rate information associated with electromagnetic waves generated by the electronic device according to a first wireless communication method, and second specific absorption rate information associated with electromagnetic waves generated by the electronic device according to a second wireless communication method, wherein the application processor is configured to receive the first specific absorption rate information and the second specific absorption rate information from the at least one communication processor, generate integrated specific absorption rate information, based on one or both of the first specific absorption rate information or the second specific absorption rate information, determine whether to adjust a transmission power of the first wireless communication method or a transmission power of the second wireless communication method based on the integrated specific absorption rate information, and transmit a transmission power control request to the at least one communication processor to adjust one or both of the transmission power of the first wireless communication method or the transmission power of the second wireless communication method based on a determination to adjust one or both of the transmission power of the first wireless communication method or the transmission power of the second wireless communication method.

According to embodiments of the present disclosure, there is provided an electronic device including a memory and at least one application processor electrically connected to the memory and configured to execute at least one computer-readable program included in the memory, wherein the at least one computer-readable program comprises instructions to receive first specific absorption rate information associated with electromagnetic waves generated by the electronic device according to a first wireless communication method and second specific absorption rate information associated with electromagnetic waves generated by the electronic device according to a second wireless communication method from at least one communication processor communicable with the application processor, generate integrated specific absorption rate information based on one or both of the first specific absorption rate information or the second specific absorption rate information, determine whether to adjust a transmission power of the first wireless communication method or a transmission power of the second wireless communication method based on the integrated specific absorption rate information, and transmit a transmission power control request to the at least one communication processor to adjust one or both of the transmission power of the first wireless communication method or the transmission power of the second wireless communication method based on a determination to adjust one or both of the transmission power of the first wireless communication method or the transmission power of the second wireless communication method.

According to embodiments of the present disclosure, there is provided an electronic device including a memory, and at least one communication processor electrically connected to the memory, and configured to execute at least one computer-readable program included in the memory, wherein the at least one computer-readable program is configured to calculate a time-based specific absorption rate according to a wireless communication method, determine whether the time-based specific absorption rate according to the wireless communication method exceeds a threshold value, and in response to determining that the time-based specific absorption rate according to the wireless communication method exceeds the threshold value, transmit information related to the time-based specific absorption rate according to the wireless communication method to an application processor that is configured to communicate with the at least one communication processor.

According to embodiments, a specific absorption rate budget may be effectively used by integrally managing the specific absorption rates according to various wireless communication methods.

According to embodiments, information transmission for integrally managing the specific absorption rate is performed at a time when another processor is predicted to be activated, thereby reducing power consumption.

The effect that is obtained from the present disclosure is not limited to the above. The technical effect not mentioned above may be explicitly known to those skilled in the art from the description below.

### BRIEF DESCRIPTION OF DRAWINGS

FIG. 1 is a view illustrating an example of a network environment including an electronic device according to embodiments of the present disclosure;

FIG. 2 is a block view illustrating an example of an electronic device according to embodiments of the present disclosure;

FIG. 3 is a block view illustrating an example of a program module according to embodiments of the present disclosure;

FIG. 4 is an exemplary view illustrating an electronic device supporting a plurality of wireless communication methods according to embodiments of the present disclosure;

FIG. 5 is a block view illustrating an example of an electronic device that integrally manages a specific absorption rate according to various wireless communication methods according to embodiments of the present disclosure;

FIG. 6 is a block view illustrating an example of an electronic device that manages a specific absorption rate in an integrated manner according to various wireless communication methods according to embodiments of the present disclosure;

FIG. 7 is a flowchart illustrating an example of an integrated management method of a specific absorption rate according to embodiments of the present disclosure;

FIG. 8 is a block view illustrating an example of an electronic device that manages a specific absorption rate in an integrated manner according to various wireless communication methods according to embodiments of the present disclosure;

FIG. 9 is a flowchart illustrating an example of a specific absorption rate information transmission method according to embodiments of the present disclosure;

FIG. 10 is a flowchart illustrating an example of a power control request transmission method according to embodiments of the present disclosure;

FIG. 11 is a flowchart illustrating an example of a transmission power control method according to embodiments of the present disclosure;

FIG. 12 is a block view illustrating an example of an electronic device that manages a specific absorption rate in an integrated manner according to various wireless communication methods according to embodiments of the present disclosure;

FIG. 13 is a flowchart illustrating an example of a specific absorption rate information request method according to embodiments of the present disclosure; and

FIG. 14 is a flowchart illustrating an example of a method for collecting specific absorption rate information according to embodiments of the present disclosure.

### DETAILED DESCRIPTION

Throughout the specification, when a component is described as “including” a particular element or group of elements, it is to be understood that the component is formed of only the element or the group of elements, or the element or group of elements may be combined with additional elements to form the component, unless the context clearly and/or explicitly describes the contrary.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

As used herein, components described as being “electrically connected” are configured such that an electrical signal can be transferred from one component to the other (although such electrical signal may be attenuated in strength as it is transferred and may be selectively transferred).

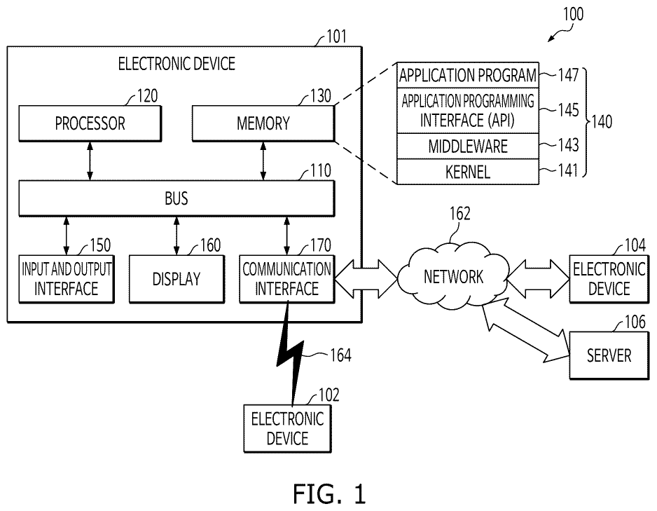

Embodiments of the technical spirit of the present disclosure will be described in detail with reference to FIG. 1 to FIG. 14. Like reference numerals in the drawings denote like elements throughout the specification.

An electronic device according to various embodiments of the present disclosure may include, for example, at least one of a smartphone, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, or a wearable device. A wearable device may include at least one of an accessory type (e.g., a watch, a ring, a bracelet, an anklet, a necklace, glasses, contact lenses, or a head-mounted device (HMD)), a fabric or clothing-integrated (e.g., an electronic garment), a body-attached (e.g., a skin pad or tattoo), or an implantable circuit. According to embodiments, the electronic device may include at least one of, for example, a television, a digital video disk (DVD) player, an audio player, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, or an electronic picture frame.

According to another embodiment, the electronic device may include at least one of various medical devices (e.g., various portable medical measuring devices (e.g., a blood glucose meter, a heart rate meter, a blood pressure meter, or a body temperature meter), magnetic resonance angiography (MRA), magnetic resonance imaging (MRI), computed tomography (CT), a camera, or an ultrasound machine), a navigation device, a global navigation satellite system (GNSS), an event data recorder (EDR), a flight data recorder (FDR), an automobile infotainment device, electronic equipment for ships (e.g., a navigation device for ships, a gyro compass, etc.), avionics, a security device, a head unit for vehicles, an industrial or household robot, a drone, an ATM of financial institutions, a POS (point of sales) of stores, or an Internet of Things device (e.g., a light bulb, various sensors, a sprinkler device, a fire alarm, a thermostat, a streetlight, a toaster, an exercise device, a hot water tank, a heater, a boiler, etc.). According to embodiments, the electronic device may include at least one of a piece of furniture, a building/structure, a vehicle, an electronic board, an electronic signature receiving device, a projector, or various measuring devices (e.g., water, electricity, gas, or radio wave measuring device, etc.). In various embodiments, the electronic device may be a combination of two or more of the various devices described above. The electronic device according to the embodiments of the present disclosure is not limited to the above.

FIG. 1 is a view illustrating an example of a network environment 100 including an electronic device 101 according to embodiments of the present disclosure.

Referring to FIG. 1, an electronic device 101 may include a bus 110, a processor 120, a memory 130, an input and output interface 150, a display 160, and a communication interface 170.

The bus 110 may connect elements (e.g., 110 to 170) to each other, and include a circuit that transmits communication (e.g., a control message or data) between elements.

The processor 120 may include at least one of a central processing unit, an application processor (AP), or a communication processor (CP). The processor 120 may execute or perform calculations or data processing to control and/or manage communication of at least one of the other elements of the electronic device 101.

The memory 130 may include a volatile memory or a non-volatile memory. The memory 130 may store commands or data related to at least one of the other elements of the electronic device 101. For example, the memory 130 may store commands associated with the processor 120 (e.g., an application processor and/or a communication processor), and the processor 120 may execute the commands stored in the memory 130. According to embodiments, the memory 130 may store software and/or a program 140.

The program 140 may include, for example, a kernel 141, a middleware 143, an application programming interface (API) 145 and/or an application program (or application) 147. At least a part of the kernel 141, the middleware 143, or the API 145 may be referred to as an operating system. The kernel 141 may control or manage, for example, system resources (e.g., the bus 110, the processor 120, or the memory 130) used to execute operations or functions implemented in other programs (e.g., the middleware 143, the API 145, or the application program 147). The kernel 141 may access the individual elements of the electronic device 101 in the middleware 143, the API 145 or the application program 147 to provide an interface to control or manage system resources.

The middleware 143 may function as a medium to allow the API 145 or the application program 147 to communicate with the kernel 141 for exchanging data. In addition, the middleware 143 may process one or more task requests received from the application program 147 according to priorities. For example, the middleware 143 may give priority to at least one of the application programs 147 to use a system resource (e.g., the bus 110, the processor 120 or the memory 130) of the electronic device 101 and process the one or more task requests described above. The API 145 may be an interface in which the application program 147 controls the functions provided from the kernel 141 or the middleware 143, and may include at least one interface or function (e.g., a command) for file control, window control, image processing, or text control.

The input and output interface 150, for example, may transmit the command or data input from a user or an external device to other elements of the electronic device 101, or output the command or data received from the other elements of the electronic device 101 to the user or the external device.

The display 160 may include, for example, a liquid crystal display (LCD), a light emitting diode (LED) display, an organic light emitting diode (OLED) display, a micro electro mechanical systems (MEMS) display, or an electronic paper display. The display 160 may display various contents (e.g., text, images, videos, icons, and/or symbols) to the user. The display 160 may include a touch screen and may receive touch, gesture, and proximity or hovering inputs using an electronic pen or a part of the user body.

The communication interface 170 may set the communication between the electronic device 101 and an external device (e.g., a first external electronic device 102, a second external electronic device 104, or a server 106). For example, the communication interface 170 may be connected to a network 162 in a wired or wireless connection to communicate with an external device (e.g., the second external electronic device 104 or the server 106). According to embodiments, the communication interface 170 may transmit a packet. The communication interface 170 may transmit a packet according to the target transmission power determined by the processor 120.

The wireless communication may include at least one of cellular communication using at least one of LTE, LTE Advance (LTE-A), code division multiple access (CDMA), wideband CDMA (WCDMA), universal mobile telecommunications system (UMTS), Wireless Broadband (WiBro), or Global System for Mobile Communications (GSM), a Wireless Local Area Network (WLAN) (e.g., wireless fidelity (WiFi)), Bluetooth, Bluetooth Low Energy (BLE), Zigbee, near field communication (NFC), Magnetic Secure Transmission, radio frequency (RF), or a body area network (BAN). According to embodiments, the wireless communication may include a global navigation satellite system (GNSS). The GNSS may be, for example, Global Positioning System (GPS), Global Navigation Satellite System (Glonass), Beidou Navigation Satellite System (referred to as “Beidou”) or Galileo, the European global satellite-based navigation system. In this specification, “GPS” may be used interchangeably with “GNSS”. The wired communication may include, for example, at least one of universal serial bus (USB), high-definition multimedia interface (HDMI), recommended standard 232 (RS-232), power line communication or plain old telephone service (POTS). The network 162 may include a telecommunications network, for example, a computer network (e.g., LAN or WAN), the Internet or a telephone network.

The first external electronic device 102 and the second external electronic device 104 may be the same as or different from the electronic device 101. According to embodiments, all or a part of the operations executed by the electronic device 101 may be executed by a single electronic device or a plurality of electronic devices (e.g., electronic devices 102 and 104) or the server 106. According to embodiments, when the electronic device 101 performs a function or a service automatically or upon a request, the electronic device 101 may execute the functions or services by itself, or may transmit a request to other devices (e.g., the electronic devices 102 and 104 or the server 106) to perform a part of the functions. The other electronic devices (e.g., the electronic devices 102 and 104 or the server 106) may execute the requested function or additional function, and transmit the executed functions to the electronic device 101. The electronic device 101 may provide the requested functions or services to the other electronic devices. Cloud computing, distributed computing or client-server computing technology may be used.

FIG. 1 illustrates elements of the electronic device 101, and illustrates the function of the elements of the electronic device 101. However, FIG. 1 is not intended to be limiting.

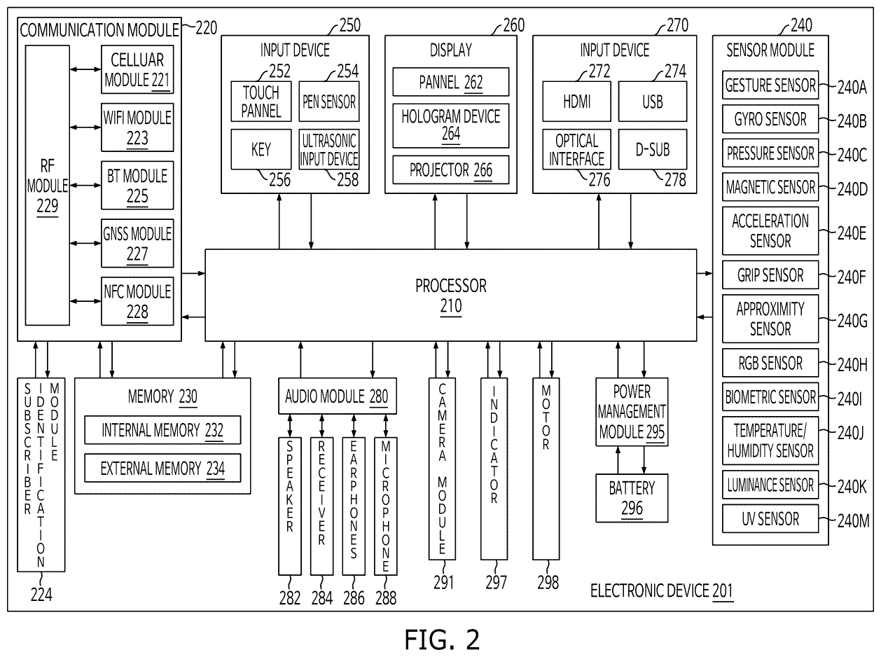

FIG. 2 is a block view illustrating an example of an electronic device 201 according to embodiments of the present disclosure. The electronic device 201 may include all or a part of the electronic device 101 illustrated in FIG. 1.

Referring to FIG. 2, the electronic device 201 may include one or more of processors 210 (e.g., AP), a communication module 220, a subscriber identification module 224, a memory 230, a sensor module 240, an input and output device 250, a display 260, an interface 270, an audio module 280, a camera module 291, a power management module 295, a battery 296, an indicator 297, and a motor 298.

The processor 210 may control a number of hardware or software elements connected to the processor 210 by driving an operating system or an application program and by performing various data processing functions and calculations. According to embodiments, the processor 210 may be implemented as a system on chip (SoC). According to embodiments, the processor 210 may further include a graphic processing unit (GPU) and/or an image signal processor. According to embodiments, the processor 210 may include one or more of the elements illustrated in FIG. 2 and/or at least a part of the processor 210 may be included in at least a portion of the elements illustrated in FIG. 2. The processor 210 may load commands or data received from at least one of the other elements (e.g., a non-volatile memory, etc.) into a volatile memory and process the received command or data and store resulting data in a non-volatile memory.

The communication module 220 may establish a direct (e.g., wired) communication channel or a wireless communication channel between the electronic device 201 and an external electronic device or perform communication through the established communication channel. The communication module 220 may operate independently from at least part of the processor 210 (e.g., an application processor), and include one or more of communication processors that support a direct (e.g., wired) communication or wireless communication. According to embodiments, the communication module 220 may include a wireless communication module (e.g., a cellular module 221, a WiFi module 223, a Bluetooth module 225, a GNSS module 227, an NFC module 228, an RF module 229, etc.) and/or a wired communication module (e.g., a local area network (LAN) communication module, a power line communication module, etc.). Various types of communication modules may be integrated into a single element (e.g., a single chip) or implemented as multiple separate elements (e.g., multiple chips).

The cellular module 221 may provide, for example, voice calls, video calls, text services, or Internet services through a communication network. According to embodiments, the cellular module 221 may perform identification and authentication of the electronic device 201 within a communication network by using a subscriber identification module 224 (e.g., a SIM card).

According to embodiments, the cellular module 221 may perform at least part of the functions provided by the processor 210. According to embodiments, the cellular module 221 may include a communication processor. At least part (e.g., two or more) of the cellular module 221, a WiFi module 223, a Bluetooth module 225, a GNSS module 227, or an NFC module 228 may be included in one integrated chip (IC) or IC package. The RF module 229 may transmit and receive a communication signal (e.g., an RF signal). The RF module 229 may include, for example, a transceiver, a power amp module (PAM), a frequency filter, a low noise amplifier (LNA), or an antenna. According to another embodiment, at least one of the cellular module 221, the WiFi module 223, the Bluetooth module 225, the GNSS module 227, or the NFC module 228 may transmit and receive RF signals through a separate RF module.

The subscriber identification module 224 may include a card or an embedded SIM including a subscriber identification module and include unique identification information (e.g., an integrated circuit card identifier (ICCID)) or subscriber information (e.g., international mobile subscriber identity (IMSI)). The memory 230 (e.g., the memory 130) may include, for example, a built-in memory 232 or an external memory 234. The built-in memory 232 may include at least one of a volatile memory (e.g., DRAM, SRAM, or SDRAM), a non-volatile memory (e.g., one-time programmable ROM (OTPROM)), PROM, EPROM, EEPROM, mask ROM, flash ROM, flash memory, a hard drive, or a solid state drive (SSD). The external memory 234 may include a flash drive, for example, a compact flash (CF), a secure digital (SD), a Micro-SD, a Mini-SD, an extreme digital (xD), a multi-media card (MMC), or a memory stick. The external memory 234 may be functionally or physically connected to the electronic device 201 through various interfaces.

The sensor module 240 may measure physical quantities or detect the operation status of the electronic device 201 and convert the measured or detected information into electrical signals. According to embodiments, the sensor module 240 may detect an event for the electronic device 201. The event may be an event affecting power absorbed into a user of the power output from the electronic device 201 (e.g., human body proximity status change event, etc.). The sensor module 240 may include, for example, at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, an illuminance sensor 240K, or an ultra violet UV sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors. According to embodiments, the electronic device 201 may further include a processor configured to control the sensor module 240, wherein the processor is a part of the processor 210. Alternatively, the electronic device 201 may include a processor that is separate from the processor 210, such that the processor can separately control the sensor module 240 when the processor 210 is in a sleep mode.

The input device 250 may include, for example, a touch panel 252, a (digital) pen sensor 254, a key 256, or an ultrasonic input device 258. The touch panel 252 may use at least one of, for example, an electrostatic method, a resistive method, an infrared or an ultrasonic method. In addition, the touch panel 252 may further include a control circuit. The touch panel 252 may further include a tactile layer to provide a tactile response to the user. The (digital) pen sensor 254 may be, for example, a part of the touch panel, or may include a separate sheet for recognition. The key 256 may include, for example, a physical button, an optical key or a keypad. The ultrasonic input device 258 may detect ultrasonic waves generated from an input device through a microphone (e.g., a microphone 288) and identify data corresponding to the detected ultrasonic waves.

The display 260 (e.g., a display 160) may include a panel 262, a hologram device 264, a projector 266 and/or a control circuit controlling the same. The panel 262 may be flexible, transparent, or wearable. The panel 262 may include one or more modules and the touch panel 252. According to embodiments, the panel 262 may include a pressure sensor (or a pos sensor) that measures the intensity of the pressure of user touch. The pressure sensor may be integrally implemented with the touch panel 252, or configured to include one or more of sensors separate from the touch panel 252. The hologram device 264 may provide a three-dimensional image in the air by using interference of light. The projector 266 may project light into a screen to display an image. The screen may be located inside or outside the electronic device 201.

The interface 270 may include, for example, an HDMI 272, a USB 274, an optical interface 276, or a D-subminiature (D-sub) 278. The interface 270 may be included in the communication interface 170 illustrated in FIG. 1. Additionally, or alternatively, the interface 270 may include, for example, a mobile high-definition link (MHL) interface, an SD card/multi-media card (MMC) interface, or an infrared data association (IrDA) standard interface.

The audio module 280 may convert sounds into electrical signals and may convert electrical signals into sounds. At least part of the audio module 280 may be included in the input and output interface 145 illustrated in FIG. 1. The audio module 280 may process sound information input or output through, for example, a speaker 282, a receiver 284, an earphone 286, or a microphone 288.

The camera module 291 may be a device for capturing still images or moving images, and according to embodiments, may include one or more image sensors (e.g., a front sensor or a rear sensor), lens, an image signal processor (ISP) or flash (e.g., LED, xenon lamp, etc.).

The power management module 295 may manage power of the electronic device 201. According to embodiments, the power management module 295 may include a power management integrated circuit (PMIC), a charging IC, or a battery or fuel gauge. The PMIC may have a wired and/or wireless charging method. The wireless charging method may include, for example, a magnetic resonance method, a magnetic induction method, or an electromagnetic wave method, and may further include an additional circuit for wireless charging, for example, a coil loop, a resonant circuit, or a rectifier. The battery gauge may measure, for example, the remaining capacity of the battery 296, voltages during charging, currents, or temperatures. The battery 296 may include, for example, a rechargeable battery and/or a solar cell.

The indicator 297 may display specific statuses of the electronic device 201 or the part (e.g., a processor 210) of the electronic device, for example, a booting status, a message status, or a charging status. A motor 298 may convert electrical signals into machinery vibration and cause a vibration or a haptic effect.

The electronic device 201 may include a mobile TV support device (e.g., GPU) capable of processing media data according to standards such as digital multimedia broadcasting (DMB), digital video broadcasting (DVB), or mediaFlo.

Each of the elements described in this specification may include one or more components, and the terms of the corresponding components may vary depending on the types of the electronic devices. According to various embodiments, an electronic device (e.g., the electronic device (201)) may have components omitted, or include additional components or a single entity formed by combining a part of the components. However, the same functions of the corresponding components may be performed prior to combination.

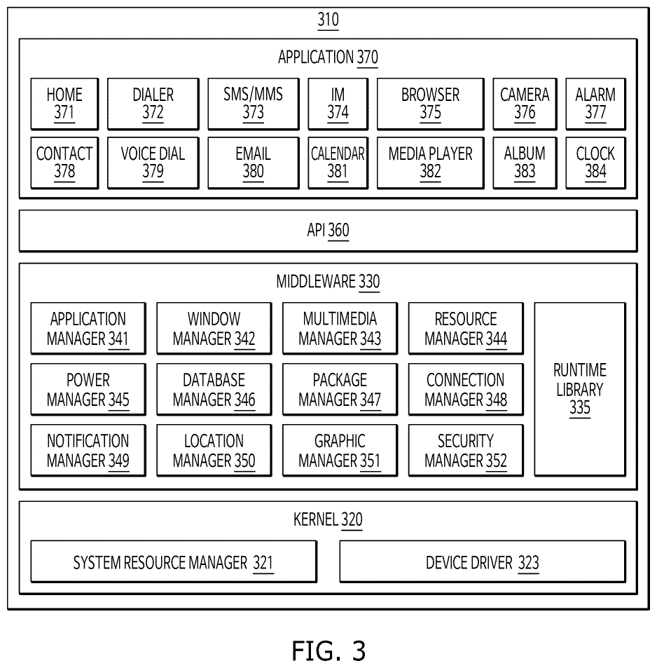

FIG. 3 is a block view illustrating an example of a program module according to embodiments of the present disclosure. According to embodiments, a program module 310 (e.g., a program 140) may include an operating system for controlling resources associated with an electronic device (e.g., the electronic device 101 of FIG. 1 and/or the electronic device 201 of FIG. 2) and/or various applications (e.g., an application program 147) driven in the operating system.

Referring to FIG. 3, the program module 310 may include a kernel 320 (e.g., the kernel 141), a middleware 330 (e.g., the middleware 143), an API 360 (e.g., the API 145) and/or an application 370 (e.g., the application program 147)). At least part of the program module 310 may be preloaded into an electronic device, or downloaded from an external electronic device (e.g., the electronic devices 102 and 104, the server 106, etc.)

The kernel 320 may include, for example, a system resource manager 321 and/or a device driver 323. The system resource manager 321 may perform control, allocation, or recovery of system resources. According to embodiments, the system resource manager 321 may include a process management unit, a memory management unit, or a file system management unit. The device driver 323 may include, for example, display drivers, camera drivers, Bluetooth drivers, shared memory drivers, USB drivers, keypad drivers, WiFi drivers, audio drivers, or inter-process communication (IPC) drivers. The middleware 330 may provide functions commonly required by the application 370 or various functions that allows the application 370 to use the limited system resources in the electronic device to the application 370 through the API 360.

The middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphics manager 351, or a security manager 352.

The runtime library 335 may include a library module used by a compiler to add new functions through a programming language when the application 370 is executed. The runtime library 335 may perform input and output management, memory management or arithmetic function process. The application manager 341 may manage the life cycle of the application 370. The window manager 342 may manage graphical user interface (GUI) resources used on the screen. The multimedia manager 343 may identify the format required for reproducing media files, and perform encoding or decoding of the media file by using a codec corresponding to the format. The resource manager 334 may manage the source code or the memory space of the application 370. The power manager 345 may manage the capacity or the power of batteries and provide power information necessary for the operation of the electronic device. The power manager 345 may be linked with a basic input/output system (BIOS). The database manager 346 may generate, retrieve, or change a database to be used in the application 370. The package manager 347 may manage installment or renewal of the application distributed in the form of a package file.

The connectivity manager 348 may manage wireless connection(s). The notification manager 349 may notify events such as arrival messages, appointments, proximity notifications to the user. The location manager 350 may manage information on the location of the electronic device. The graphic manager 351 may manage a graphic effect to be provided to the user or a user interface related thereto. The security manager 352 may provide system security or user authentication. The middleware 330 may include a manager for managing voice or video calls of the electronic device or a middleware module capable of combining the functions of the above-described elements. The middleware 330 may provide a module specialized for each type of the operating system. The middleware 330 may dynamically delete a part of the elements or add new elements. The API 360 may be a collection of API programming functions, and may be provided as a different configuration according to the operating system. For example, for Android or iOS, a single set of API may be provided for each platform, and for Tizen, two or more sets of APIs may be provided for each platform.

The application 370 may include, for example, a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, a watch 384, health care (e.g., measuring the amount of exercise or blood glucose, etc.) or environmental information (e.g., information on an atmospheric pressure, a humidity, or a temperature). According to embodiments, the application 370 may include an information exchange application for supporting information exchange between an electronic device or an external electronic device. The information exchange application may include a notification relay application for transmitting specific information to the external electronic device or a device management application for managing the external electronic device. For example, a notification transmission application may transmit notification information generated by another application of the electronic device to the external electronic device or receive notification information from the external electronic device to provide the notification information to the user. The device management application may install, delete, or renew functions (e.g., turn-on/turn-off of the external electronic device (or components) or adjustment of lightness (or a resolution) of a display) of the external electronic device that communicates with the electronic device, or applications operated by the external electronic device. The application 370 may include applications (e.g., a health care application of a mobile medical device) designated according to the characteristics of the external electronic device. The application 370 may include applications received from the external electronic device. At least part of the program module 310 may be implemented (e.g., executed) by software, firmware, hardware (e.g., a processor (210)), or a combination thereof, and may include modules, programs, routines, instruction sets, or processes for performing one or more functions.

The term ‘module’ used in the present disclosure may include a unit consisting of hardware, software or firmware, and may be used interchangeably with the terms such as logic, logic block, component or circuit. ‘Module’ may be one integrated component or a minimum unit or a part thereof that performs one or more functions. ‘Module’ may be implemented mechanically or electronically, and may include, for example, an application-specific integrated circuit (ASIC) chip, field-programmable gate arrays (FPGAs) or programmable logic device that performs certain operations. At least a part of devices (e.g., modules or functions) or methods (e.g., operations) according to various embodiments may be implemented as instructions stored in a computer-readable storage medium (e.g., a memory 130) in the form of a program module. When the instructions are executed by a processor (e.g., a processor 120), the processor may perform functions corresponding to the instructions. The computer-readable recording medium may be a tangible, non-transitory medium, such as a hard disk, a floppy disk, a magnetic medium (e.g., a magnetic tape), an optical recording medium (e.g., a CD-ROM, a DVD, a magneto-optical medium (e.g., a floptical disk), a built-in memory, etc. The instructions may include codes generated by a compiler or codes executable by an interpreter. Modules or program modules according to various embodiments may include at least one or more of the above-described components, some of which may be omitted, or other components may be further included. Operations performed by modules, program modules, or other components according to various embodiments may be executed sequentially, in parallel, iteratively, or heuristically, or at least a part of the operations may be executed in a different order or omitted, or other operations may be added.

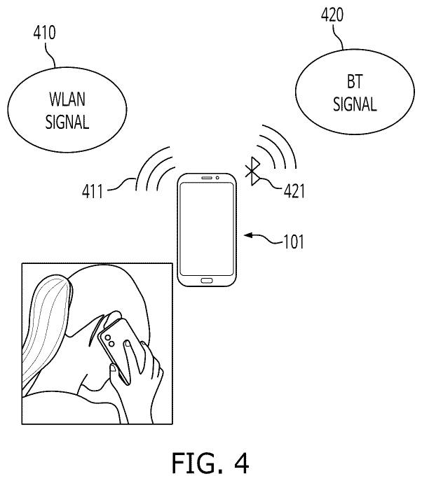

FIG. 4 is an exemplary view illustrating an electronic device 101 that supports a plurality of wireless communication methods according to embodiments of the present disclosure. Referring to FIG. 4, the electronic device 101 may support various wireless communication methods (e.g., a first communication method 411 (e.g., WLAN), a second communication method 421 (e.g., Bluetooth) etc.). For example, when performing the first communication method 411 as a WiFi communication, the electronic device 101 may supply a WLAN power based on a WLAN antenna corresponding to the first communication method 411, and transmit a first communication signal 410 corresponding to a WLAN communication frequency through the WLAN antenna. For another example, when performing the second communication method 421 as a Bluetooth communication, the electronic device 101 may supply a Bluetooth power based on a Bluetooth antenna corresponding to the second communication method 421, and transmit a second communication signal 420 corresponding to a Bluetooth communication frequency through the Bluetooth antenna.

According to embodiments, the electronic device 101 may include a plurality of antennas for supporting a plurality of wireless communication methods, and each of the antennas may be designed based on the frequency region of the wireless communication method. According to embodiments, the electronic device 101 may support a plurality of wireless communication methods through a communication module (e.g., the communication interface 170 of FIG. 1, the communication module 220 of FIG. 2, etc.). The electronic device 101 may communicate by using each wireless communication method (e.g., the first communication method communication 411, the second communication method 421, etc.) individually, or by using multiple methods simultaneously.

The electronic device 101 may radiate electromagnetic waves for wireless communication. A portion of the radiated electromagnetic waves may be transmitted to the user of the electronic device 101. A specific absorption rate (SAR) may represent the amount of radiated electromagnetic waves that are absorbed into the body of the user. The electronic device 101 may be designed to adjust a transmission power of the wireless communication methods so that the intensity of the electromagnetic waves radiated from the electronic device 101 is unlikely to cause harm to the user. According to embodiments, the electronic device 101 may integrally manage a specific absorption rate according to various wireless communication methods. The description thereof will be detailed below.

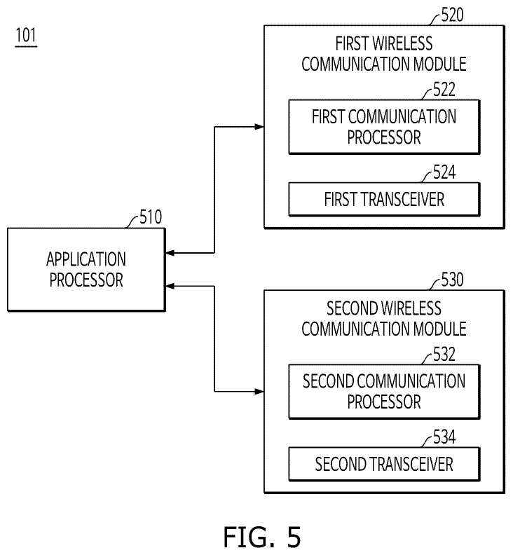

FIG. 5 is a block view illustrating an example of the electronic device 101 that manages a specific absorption rate in an integrated manner according to various wireless communication methods. Referring to FIG. 5, the electronic device 101 may include an application processor 510 and one or more wireless communication modules, for example, a first wireless communication module 520 and a second wireless communication module 530.

The wireless communication modules 520 and 530 may establish a wireless communication channel between the electronic device 101 and the external electronic device (e.g., another electronic device, an access point, a server, etc.) and may control communications through the established communication channel. According to embodiments, the first wireless communication module 520 and the second wireless communication module 530 may support a different wireless communication method. For example, the first wireless communication module 520 may support a first wireless communication method (e.g., a WLAN communication), and a second wireless communication module 530 may support a second wireless communication method (e.g., Bluetooth communication) different from the first wireless communication method. The first wireless communication module 520 and the second wireless communication module 530 may be integrated as a single element (e.g., a single chip) or implemented as a plurality of separate elements (e.g., a plurality of chips).

The first wireless communication module 520 may include a first communication processor 522 and a first transceiver 524. The first communication processor 522 may calculate a time-based specific absorption rate according to the first wireless communication method, and store the calculated time-based specific absorption rate in a memory electrically connected to the first communication processor 522. The time-based specific absorption rate according to the first wireless communication method may represent the amount of electromagnetic waves generated by the electronic device 101 according to the first wireless communication method that are absorbed into the human body. The time-based specific absorption rate according to the first wireless communication method may be calculated based on the transmission power of the first wireless communication module 520, the size (e.g., the capacity) of signals or data transmitted in the first wireless communication method, the proximity of the electronic device 101 to the human body, etc.

According to embodiments, the time-based specific absorption rate is the specific absorption rate during a predetermined time section or time period. The predetermined time section is measured between a current time point t(s) and a predefined time point a(s), such that the predetermined time section is from a time point t−a(s) to the current time point t(s). The first communication processor 522 may transmit the time-based specific absorption rate information according to the first wireless communication method during the predetermined time section to an application processor 510 as first specific absorption rate information. Accordingly, the first specific absorption rate information that is transmitted by the first wireless communication module 520 to the application processor 510 may include the time-based specific absorption rate according to the first wireless communication method.

According to embodiments, the first communication processor 522 may receive a transmission power control request for controlling a transmission power of the first wireless communication method from the application processor 510. The first communication processor 522 may adjust the transmission power of the first wireless communication method upon receiving the transmission power control request. The first transceiver 524 may transmit and receive signals and/or data according to the first wireless communication method.

The second wireless communication module 530 may include a second communication processor 532 and a second transceiver 534. The second communication processor 532 may calculate a time-based specific absorption rate according to the second wireless communication method, and store the calculated time-based specific absorption rate in a memory electrically connected to the second communication processor 532. The time-based specific absorption rate according to the second wireless communication method may represent the amount of electromagnetic waves generated by the electronic device 101 according to the second wireless communication method that are absorbed into the user body. The time-based specific absorption rate according to the second wireless communication method may be calculated based on the transmission power of the second wireless communication module 530, the size (e.g., the capacity) of signals or data transmitted in the second wireless communication method, the proximity of the electronic device 101 to the human body, etc.

According to embodiments, the second communication processor 532 may transmit time-based specific absorption rate information according to the second wireless communication method to the application processor 510 as second specific absorption rate information. Accordingly, the second specific absorption rate information that is transmitted by the second wireless communication module 530 to the application processor 510 may include the time-based specific absorption rate according to the second wireless communication method. The second communication processor 532 may receive a transmission power control request for controlling a transmission power of the second wireless communication method from the application processor 510. The second communication processor 530 may adjust the transmission power of the second wireless communication method upon receiving the transmission power control request. The second transceiver 534 may transmit and receive signals and/or data according to the second wireless communication method.

Signals or data transmitted through the first transceiver 524 and/or the second transceiver 534 may include control signals transmitted to maintain the connection to the external electronic device (e.g., another electronic device, an access point, etc.) and/or user data generated by a user using the electronic device 101. The control signal may be generated by the wireless communication modules 520 and 530, and user data may be received by the wireless communication modules 520 and 530 from the application processor 510.

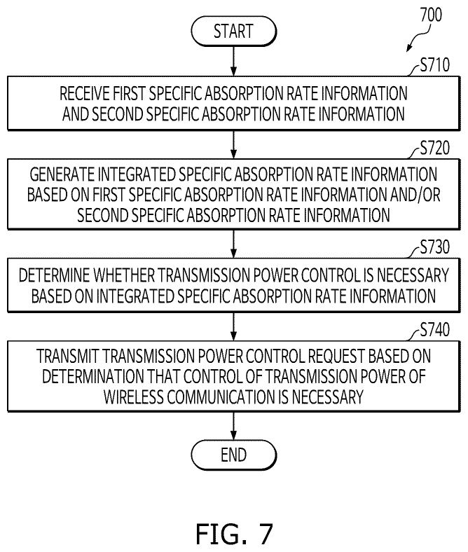

The application processor 510 may receive the first specific absorption rate information from the first communication processor 522, and receive the second specific absorption rate information from the second communication processor 532. The application processor 510 may manage a specific absorption rate according to the first wireless communication method and/or the second wireless communication method based on the received first specific absorption rate information and/or second specific absorption rate information in an integrated manner. For example, the application processor 510 may combine or jointly analyze the first specific absorption rate information and the second specific absorption rate information when determining whether to adjust the transmission power of the first wireless communication module 520 and/or the transmission power of the second wireless communication module 530. The determination of whether to adjust the transmission power of the first wireless communication module 520 and/or the transmission power of the second wireless communication module 530 may be based, in part, on whether the first specific absorption rate and/or the second specific absorption rate exceeds a threshold. When it is determined to adjust the transmission power of the first wireless communication method and/or the second wireless communication method with respect to a specific absorption rate, the application processor 510 may transmit a transmission power control request to one or both of the first communication processor 522 or the second communication processor 532. The description thereof will be detailed with reference to FIG. 7.

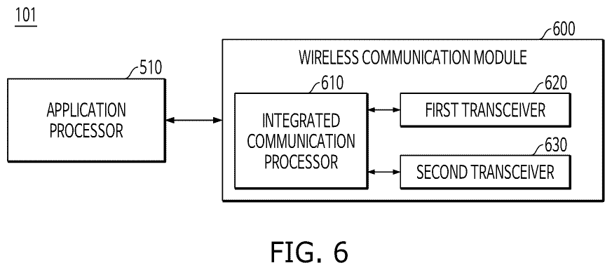

Referring to FIG. 5, although the electronic device 101 is illustrated as including separate communication processors 522 and 532 that support the wireless communication method, the present disclosure is not limited thereto. The electronic device 101 may include an integrated communication process that supports a plurality of wireless communication methods. The description thereof will be detailed below with reference to FIG. 6.

FIG. 6 is a block view illustrating an example of an electronic device 101 that manages a specific absorption rate according to various wireless communication methods in an integrated manner. The description of the electronic device 101 with reference to FIG. 5 may be applied to the electronic device 101 of FIG. 6 in the similar or same manner. The redundant description will be omitted or briefly described, and the description below will focus on additions and/or changes.

Referring to FIG. 6, the electronic device 101 may include the application processor 510 and a wireless communication module 600. The wireless communication module 600 may establish a wireless communication channel between the electronic device 101 and the external electronic device (e.g., another electronic device, an access point, a server, etc.) and may control communications through the established communication channel. According to embodiments, the wireless communication module 600 may support various wireless communication methods. For example, the wireless communication module 600 may support the first wireless communication method (e.g., WLAN communication) and the second wireless communication method (e.g., Bluetooth communication).

The wireless communication module 600 may include an integrated communication processor 610, a first transceiver 620, and a second transceiver 630. The integrated communication processor 610 is electrically connected to the first transceiver 620 and the second transceiver 630. The integrated communication processor 610 may transmit and receive signals and data with the first transceiver 620, and the integrated communication processor 610 may transmit and receive signals and data with the second transceiver 630. The first transceiver 620 may transmit and receive signals and data according to the first wireless communication method, and the second transceiver 630 may transmit and receive signals and data according to the second wireless communication method.

The integrated communication processor 610 may calculate a time-based specific absorption rate according to the first wireless communication method and a time-based specific absorption rate according to the second wireless communication method. The integrated communication processor 610 may store the calculated time-based specific absorption rate according to the first wireless communication method in the memory electrically connected to the integrated communication processor 610. The integrated communication processor 610 may store the calculated time-based specific absorption rate according to the second wireless communication method in the memory electrically connected to the integrated communication processor 610. According to embodiments, the time-based specific absorption rate for the first wireless communication method is the specific absorption rate during a predetermined time section that is measured between a first time point t1(s) and a predefined time point a(s), such that the predetermined time section is from a time point t1−a(s) to the first time point t1(s). The integrated communication processor 610 may transmit the time-based specific absorption rate information according to the first wireless communication method to the application processor 510 as the first specific absorption rate information at the first time point. The time-based specific absorption rate for the second wireless communication method is the specific absorption rate during a predetermined time section that is measured between a second time point t2(s) and a predefined time point a(s), such that the predetermined time section is from a time point t2−a(s) to the second time point t2(s). The integrated communication processor 610 may transmit the time-based specific absorption rate information according to the second wireless communication method to the application processor 510 as the second specific absorption rate information at the second time point. The first time point and the second time point may be the same or different from each other. When the first time point and the second time point are the same, the time-based specific absorption rate for the first wireless communication method may be calculated over the same predetermined time section as the time-based specific absorption rate for the second wireless communication method.

According to embodiments, the integrated communication processor 610 may receive a transmission power control request from the application processor 510, and the integrated communication processor 610 may adjust a transmission power of the first wireless communication method and/or the second wireless communication method upon receiving the transmission power control request.

The application processor 510 may receive the first specific absorption rate information and the second specific absorption rate information from the integrated communication processor 610. The application processor 510 may manage a specific absorption rate according to a wireless communication in an integrated manner based on the received first specific absorption rate information and second specific absorption rate information. For example, the application processor 510 may combine or jointly analyze the first specific absorption rate information and the second specific absorption rate information when determining whether to adjust the transmission power of the first wireless communication method or the transmission power of the second wireless communication method. The determination of whether to adjust the transmission power may be based, in part, on whether the first specific absorption rate and/or the second specific absorption rate exceeds a threshold. When it is determined to adjust the transmission power of the first wireless communication method and/or the second wireless communication method with respect to the specific absorption rate, the application processor 510 may transmit the transmission power control request to the integrated communication processor 610.

The processors disclosed herein, for example, the application processor 510 of FIG. 5 and FIG. 6, the first communication processor 522 of FIG. 5, the second communication processor 532 of FIG. 5, the integrated communication processor 610 of FIG. 6, etc., may operate in a normal mode or a sleep mode. Sleep mode is a low-power mode in which some blocks are in an inactive state, and one block (e.g., an alive block) is in an active state. For example, in the sleep mode, all of the blocks except for the alive block and the memory may be in the inactive state, and the data in the memory may be maintained in a minimal power state. The alive block may be a block maintained to be activated (alive) in all operation modes, such that the alive block may detect an interrupt. When a processor is in the normal mode, the processor may be in an active, or fully powered, operational state. The application processor 510, the first communication processor 522, the second communication processor 532, and the integrated communication processor 610 may operate independently of one another, and the power mode of these processors may be changed independently of one another. For example, at a specific moment, one or more of the processors 510, 522, 532, 610 may operate in a normal mode, but other processors 510, 522, 532, 610 may operate in a sleep mode.

FIG. 7 is a flowchart illustrating an example of a specific absorption rate integrated management method 700 according to embodiments of the present disclosure. According to embodiments, the specific absorption rate integrated management method 700 may be performed by the application processor 510.

The application processor 510 may receive the first specific absorption rate information associated with the first wireless communication method, and may receive the second specific absorption rate information associated with the second wireless communication method from at least one communication processor (e.g., the first communication processor 522, the second communication processor 532, or the integrated communication processor 610) in step S710. The first specific absorption rate information may include information on the time-based specific absorption rate according to the first wireless communication method, and the second specific absorption rate information may include information on the time-based specific absorption rate according to the second wireless communication method.

For example, the application processor 510 may receive the first specific absorption rate information from the first communication processor 522 that supports the first wireless communication method, and the second specific absorption rate information from the second communication processor 532 that supports the second wireless communication method. In another example, the application processor 510 may receive the first specific absorption rate information and the second specific absorption rate information from the integrated communication processor 610 that supports various wireless communication methods, for example, the first wireless communication method and the second wireless communication method.

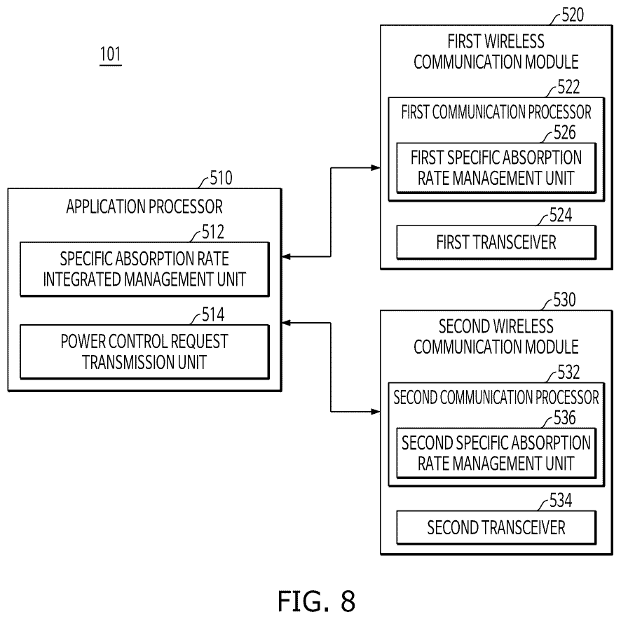

In some embodiments, the application processor 510 may be in sleep mode when one of the communication processors 522, 532, 610 attempts to transmit specific absorption rate information to the application processor 510. With the application processor 510 in sleep mode, the application processor 510 may be unnecessarily activated from sleep mode to normal mode to receive the specific absorption rate information, which reduces power efficiency. Therefore, according to embodiments of the present disclosure, at least one communication processor 522, 532, 610 may transmit specific absorption rate information to the application processor 510 when meaningful specific absorption rate information is collected or, at a time when the application processor 510 is expected to be out of sleep mode. Additionally, or alternatively, according to embodiments, the application processor 510 may transmit a request for specific absorption rate information to at least one communication processor 522, 532, 610 at a time when meaningful specific absorption rate information is collected (or, at a time when the communication processor 522, 532, 610 is expected to be out of the sleep mode). The description thereof will be detailed with reference to FIG. 8 to FIG. 14.

The application processor 510 may generate integrated specific absorption rate information associated with electromagnetic waves generated by the electronic device 101 according to the first wireless communication method and/or the second wireless communication method in step S720. The integrated specific absorption rate information may include information on an average specific absorption rate during a predefined time section according to the wireless communication including the first wireless communication method and/or the second wireless communication method. The integrated specific absorption rate information may include a combination of the first specific absorption rate information and the second specific absorption rate information, such as a summation of the first specific absorption rate information and the second specific absorption rate information, or a time-average of the first specific absorption rate information and the second specific absorption rate information over a predefined time period. The integrated specific absorption rate may be generated based on one or both of the first specific absorption rate information and the second specific absorption rate information. For example, at a certain period of time, the integrated specific absorption may comprise only the first specific absorption rate information, while at another point in time, the integrated specific absorption may comprise only the second specific absorption rate information. When combining the first specific absorption rate information and the second specific absorption rate information to generate the integrated specific absorption rate, the first specific absorption rate information and the second specific absorption rate information may be weighted equally, or, the first specific absorption rate information may be weighted differently than the second specific absorption rate information.

The application processor 510 may determine whether to adjust the transmission power of the wireless communication, for example, the first wireless communication method and/or the second wireless communication method, based on the integrated specific absorption rate information in step 730. When it is determined to adjust the transmission power of the wireless communication (e.g., the first wireless communication method and/or the second wireless communication method), the application processor 510 can transmit a transmission power control request to at least one of the communication processors 522, 532, 610 in step S740. The transmission power control request may include a request for controlling transmission power of the first wireless communication method and/or the second wireless communication method. According to embodiments, when it is determined to adjust the transmission power of the first wireless communication method and/or the second wireless communication method, the application processor 510 may determine a target transmission power, and transmit a transmission power control request including the target transmission power. The target transmission power may be different than the power at which the communication processors 522, 532, 610 were operating when the first specific absorption rate information and the second specific absorption rate information were determined.

In some embodiments, when the application processor 510 attempts to transmit the transmission power control request to one of the communication processors 522, 532, 610, the communication processor to which the transmission power control request is being sent may be in sleep mode. The communication processor may be unnecessarily activated from sleep mode to normal mode to receive the transmission power control request, which reduces power efficiency. According to embodiments, the application processor 510 may delay the transmission of the transmission power control request to the communication processor until the communication processor is expected to be out of sleep mode and has returned to the normal mode. The description thereof will be detailed with reference to FIG. 8 to FIG. 10.

For convenience of explanation, FIGS. 8-10 relate to an electronic device 101 that includes a separate communication processor supporting each wireless communication method, for example, by comprising the first wireless communication module 520 for the first wireless communication method and the second wireless communication module 530 for the second wireless communication method. However, FIGS. 8-10 are not limited to the separate wireless communication modules, and may include the wireless communication module 600 comprising the integrated communication processor 610 that supports a plurality of wireless communication methods.

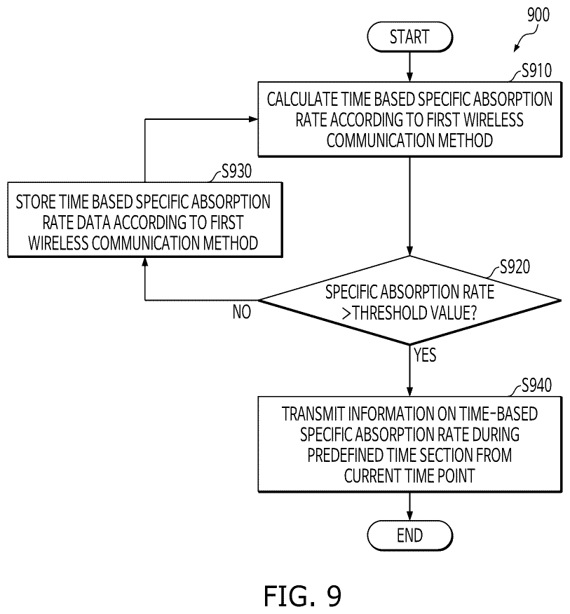

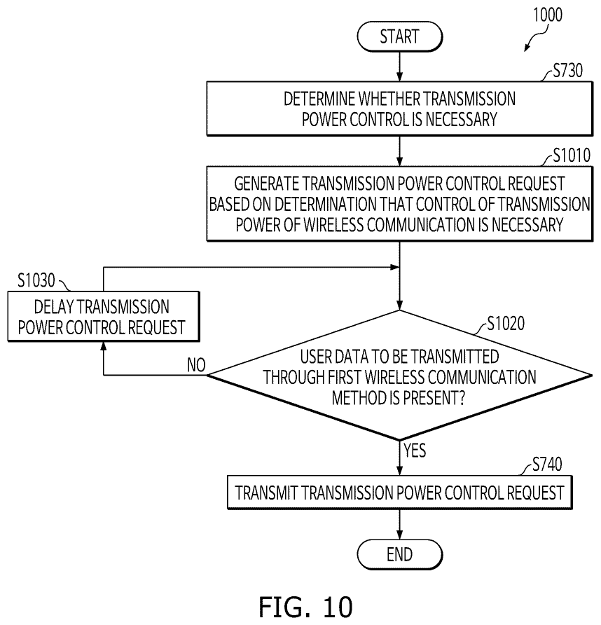

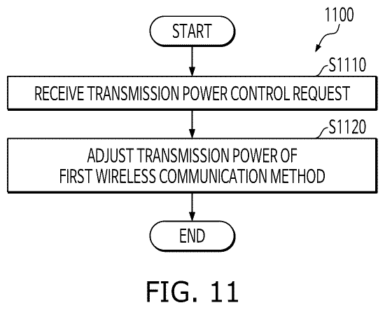

FIG. 8 is a block view illustrating an example of the electronic device 101 that integrally manages specific absorption rate information in an integrated manner according to various wireless communication methods described herein. FIG. 9 is a flowchart illustrating a specific absorption rate information transmission method 900. FIG. 10 is a flowchart illustrating a power control request transmission method 1000. FIG. 11 is a flowchart illustrating a transmission power control method 1100. The description of the electronic device 101 with reference to FIG. 5 and FIG. 6 may be applied to the electronic device 101 of FIG. 8 in the same or similar manner. The redundant description will be omitted or briefly mentioned, and the description below will focus on the additions or modifications.

Referring to FIG. 8, the electronic device 101 may include the application processor 510, the first wireless communication module 520, and the second wireless communication module 530. The first wireless communication module 520 may include the first communication processor 522 and the first transceiver 524. The first communication processor 522 may include a first specific absorption rate management unit 526. The first specific absorption rate management unit 526 may calculate a time-based first specific absorption rate according to the first wireless communication method, and store the calculated time-based first specific absorption rate in the memory electrically connected to the first communication processor 522. When it is determined that meaningful data is collected, or when the application processor 510 is expected to be out of sleep mode, the first communication processor 522 may transmit the first specific absorption rate information to the application processor 510. Meaningful data may comprise data indicative of when the calculated time-based first specific absorption rate has exceeded a predetermined threshold.

Referring to FIG. 9, the first communication processor 522 may calculate a time-based specific absorption rate according to the first wireless communication method in step S910. The first communication processor 522 may determine whether the specific absorption rate according to the first wireless communication method exceeds a predefined threshold value in step S920. For example, the first communication processor 522 may determine whether the specific absorption rate according to the first wireless communication method at the current time point exceeds a first threshold value. In an example, the first communication processor 522 may determine whether an average specific absorption rate according to the first wireless communication method exceeds a second threshold value during a first predefined time section. For the first predefined time section, the current time point may be t(s), the first predefined time point may be a1(s), and the first predefined time section may be from time point t−a1(s) to the current time point t(s).

When the specific absorption rate according to the first wireless communication method does not exceed a predefined threshold value, the first communication processor 522 may store the calculated time-based specific absorption rate data (e.g., at step S930), and continuously calculate a time-based specific absorption rate according to the first wireless communication method in step S910. When the specific absorption rate according to the first wireless communication method is determined to exceed a predefined threshold value, the first communication processor 522 may transmit information on the time-based specific absorption rate according to the first wireless communication method to the application processor 510 as first specific absorption rate information during a time section from a current time point to a second predefined time point. For this time section, the current time point may be t(s), the second predefined time point may be a2(s), and the time section may be from time point t−a2(s) to time point t(s) in step S940. The second predefined time section may be the same as or different from the first predefined time section. When the specific absorption rate information exceeds the threshold value, the application processor 510 may be activated. As such, the application processor 510 may not be unnecessarily activated due to information transmission, but, rather the application processor 510 may remain in sleep mode until the specific absorption rate information exceeds the threshold value, allowing for the specific absorption rate information to be transmitted to the application processor 510.

Referring to FIG. 8, the second wireless communication module 530 may include the second communication processor 532 and the second transceiver 534. The second communication processor 532 may include a second specific absorption rate management unit 536. The second specific absorption rate management unit 536 may calculate a time-based specific absorption rate according to the second wireless communication method, and store the calculated specific absorption rate in a memory electrically connected to the second communication processor 532. When it is determined that the meaningful data is collected, or when the application processor 510 is expected to be out of sleep mode, the second communication processor 532 may transmit the second specific absorption rate information to the application processor 510. For example, the second communication processor 532 may collect and transmit the second specific absorption rate information in the same, or similar, manner as the method for collecting or transmitting the specific absorption rate information of the first communication processor 522 described with reference to FIG. 9. Meaningful data may comprise data indicative of when the calculated time-based second specific absorption rate has exceeded a predetermined threshold.

According to embodiments in which the electronic device 101 includes the integrated communication processor 610 that supports various wireless communication methods, when it is determined that at least one of a specific absorption rate according to the first wireless communication method exceeds a first threshold value and/or a specific absorption rate according to the second wireless communication method exceeds a second threshold value, the integrated communication processor 610 may transmit the first specific absorption rate information and/or the second specific absorption rate information to the processor 510 simultaneously or sequentially.

The application processor 510 may include a specific absorption rate integrated management unit 512 and a power control request transmission unit 514. The specific absorption rate integrated management unit 512 may generate integrated specific absorption rate information associated with the electromagnetic waves generated by the electronic device 101 according to the first wireless communication method based on the first specific absorption rate information and/or the second wireless communication method based on the second specific absorption rate information. The integrated specific absorption rate information may include information on an average specific absorption rate during a predefined time section according to the first wireless communication method and/or the second wireless communication method. The integrated specific absorption rate information may include a combination of the first specific absorption rate information and the second specific absorption rate information, such as a summation of the first specific absorption rate information and the second specific absorption rate information, a time-average of the first specific absorption rate information and the second specific absorption rate information over a predefined time period, etc.

The specific absorption rate integrated management unit 512 may determine whether to adjust the transmission power of the wireless communication, for example, the first wireless communication method and/or the second wireless communication method based on the integrated specific absorption rate information.

When it is determined that the transmission power of the wireless communication (e.g., the first wireless communication method and/or the second wireless communication method) is to be adjusted, the power control request transmission unit 514 may transmit a request to at least one of the communication processors 522 and 532. The transmission power control request may include a request for controlling the transmission power of at least one of the first wireless communication method or the second wireless communication method. According to embodiments, when it is determined that the transmission power of the first wireless communication method and/or the second wireless communication method is to be adjusted, the application processor 510 may determine a target transmission power, and the power control request transmission unit 514 may transmit a transmission power control request including the target transmission power to the communication processors 522 and 532 at a time when the communication processors 522 and 532 are out of a sleep mode (i.e., an inactivate state).

Referring to FIG. 10, the application processor 510 (e.g., the specific absorption rate integrated management unit 512) may determine whether to adjust the transmission power of the first wireless communication method and/or the second wireless communication method based on the integrated specific absorption rate information in step S730. The application processor 510 may consider specific absorption rate regulations, the proximity of the electronic device 101 to the human body, the communication mode of the wireless communication module, etc. in determining whether to adjust the transmission power of the first wireless communication method and/or the second wireless communication method.

When it is determined to adjust the transmission power of the first wireless communication method and/or the second wireless communication method, the application processor 510 may generate a transmission power control request in step S1010. For example, the application processor 510 may generate a transmission power control request for a wireless communication method (e.g., WLAN communication) with a higher specific absorption rate between the first wireless communication method or the second wireless communication method. In particular, if the first wireless communication method has a first specific absorption rate and the second wireless communication method has a second specific absorption rate, and the first specific absorption rate is higher than the second specific absorption rate, then the application processor 510 may generate the transmission power control request for the first wireless communication method since the first specific absorption rate is higher than the second specific absorption rate. However, if the second specific absorption rate is higher than the first specific absorption rate, then the application processor 510 may generate the transmission power control request for the second wireless communication method. Additionally, or alternatively, the application processor 510 may generate a transmission power control request for the communication method including the user data to be transmitted according to the corresponding communication method between the first wireless communication method and the second wireless communication method. For example, if user data is present and is to be transmitted through the first wireless communication method, then the application processor 510 may generate the transmission power control request for the first wireless communication method. Accordingly, the presence of user data to be transmitted according to one of the wireless communication methods may cause the application processor 510 to generate the transmission power control request for the same wireless communication method. According to embodiments, the user data may be present, but may not have been transmitted yet according to one of the wireless communication methods, when the application processor 510 generates the transmission power control request.

According to embodiments, when the transmission power of the wireless communication is determined to be controlled, the application processor may determine a target transmission power. For example, the transmission power control request may include information on the target transmission power.

For ease of explanation, it is assumed that the transmission power control request may be a transmission power control request for the first wireless communication method. However, the present disclosure is not limited thereto, and the description below may be applied in the same or similar manner when the transmission power control request is a transmission power control request for the second wireless communication method, or a transmission power control request for both the first wireless communication method and the second wireless communication method.

The application processor 510 (e.g., the power control request transmission unit 514) may determine whether user data to be transmitted through the first wireless communication method is present in step S1020. When it is determined that the user data to be transmitted through the first wireless communication method is not present, the application processor 510 may delay the transmission of the transmission power control request in step S1030. When it is determined that user data to be transmitted through the first wireless communication method is present in step S1020, the application processor 510 may transmit a transmission power control request to at least one communication processor in step S740. For example, when the transmission power control request is a transmission power control request according to the first wireless communication method, the application processor 510 may transmit a transmission power control request to the first communication processor 522 (or the integrated communication processor 610). When the user data transmitted through the first wireless communication method is present, the first communication processor 522 (or the integrated communication processor 610) may be predicted to be out of a sleep mode, and is predicated to be in an activated status, and the first communication processor may not be unnecessarily activated due to the transmission power control request.

Referring to FIG. 11, the first communication processor 522 (or the integrated communication processor 610) may receive the transmission power control request from an application processor 510 in step S1110. According to embodiments, the transmission power control request may include information on a target transmission power. The first communication processor 522 (or the integrated communication processor 610) may adjust a transmission power according to the first wireless communication method upon receiving the transmission power control request in step S1120. For example, the transmission power in the first wireless communication method may be adjusted to the target transmission power.

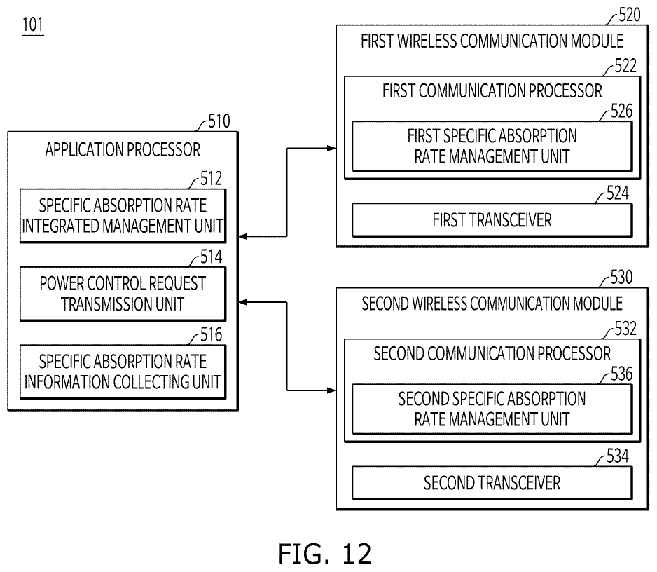

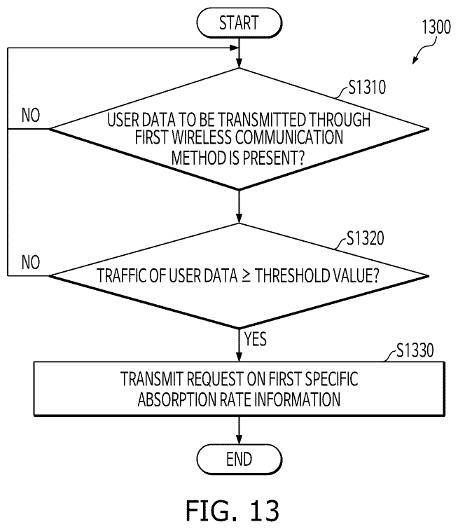

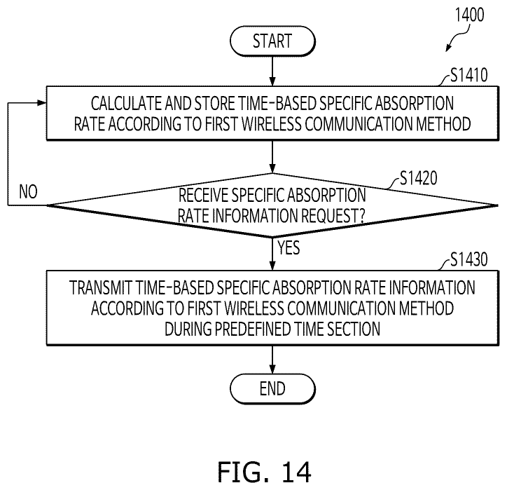

FIG. 12 is a block view illustrating an example of the electronic device 101 that integrally manages a specific absorption rate according to various wireless communication methods according to embodiments of the present disclosure. FIG. 13 illustrates examples of a specific absorption rate information request method 1300, and FIG. 14 illustrates a specific absorption rate information collecting method 1400. The description on the electronic device 101 with reference to FIG. 5 to FIG. 11 may be applied to the electronic device 101 of FIG. 12 in the same or similar manner. The redundant description will be omitted or briefly described, and the description below will focus on the additions or modifications.

Referring to FIG. 12, the electronic device 101 may include the application processor 510, the first wireless communication module 520, and the second wireless communication module 530. The application processor 510 may include the specific absorption rate integrated management unit 512, the power control request transmission unit 514, and the specific absorption rate information collecting unit 516. The specific absorption rate information collecting unit 516 may transmit a request for specific absorption rate information to at least one communication processor 522, 532. According to embodiments, the specific absorption rate information collecting unit 516 may transmit a specific absorption rate information request to at least one communication processor 522, 532 at a time when the meaningful specific absorption rate information is collected, or, when the communication processor 522, 532 is expected to be out of a sleep mode. Meaningful specific absorption rate information may comprise a time period in which the specific absorption rate has exceeded a predetermined threshold.

Referring to FIG. 13, the application processor 510 (e.g., the specific absorption rate information collecting unit 516) may determine whether user data to be transmitted through the first wireless communication method is present in step S1310. When the user data to be transmitted through the first wireless communication method is present, the application processor 510 may determine whether traffic of the user data to be transmitted through the first wireless communication method is equal to or greater than a threshold value in step S1320. The traffic of the user data may be determined by a transmission volume, for example, the total amount of data being transmitted, and/or a transmission speed. As such, the traffic of the user data may be determined when the user data is present, but prior to the transmission of the user data through the first wireless communication method. Likewise, the traffic of the user data may be compared to the threshold value when the user data is present, but prior to the transmission of the user data through the first wireless communication method. In response to determining that the traffic of the user data to be transmitted through the first wireless communication method is equal to or greater than a threshold value in step S1320, the application processor 510 may transmit a request for the first specific absorption rate information to at least one communication processor (e.g., the first communication processor 522 or the integrated communication processor 610) in step S1330. When the user data to be transmitted through the first wireless communication method is present and the traffic of the user data is equal to or greater than a threshold value, the specific absorption rate information may be collected by the application processor 510, and the first communication processor 522 may be expected to be out of a sleep mode and in an activated state. Therefore, the first communication processor 522 may be limited from being unnecessarily activated upon the request for the first specific absorption rate information.

FIG. 13 describes a method for requesting first specific absorption rate information by the application processor 510. The application processor 510 may request second specific absorption rate information in the same or similar manner as the described above.

Referring to FIG. 12, the first wireless communication module 520 may include the first communication processor 522 and the first transceiver 524. The first communication processor 522 may include the first specific absorption rate management unit 526. The first specific absorption rate management unit 526 may transmit specific absorption rate information to the application processor 510 in response to receiving a request for the specific absorption rate information from the application processor 510.

Referring to FIG. 14, the first communication processor 522 (e.g., the first specific absorption rate management unit 526) may calculate a time-based specific absorption rate according to the first wireless communication method, and store the calculated time-based specific absorption rate in the memory electrically connected to the first communication processor in step S1410. During a time when the request for the first specific absorption rate information is not received from the application processor 510 (NO in step S1420), the first communication processor 522 may calculate and store the time-based specific absorption rate according to the first wireless communication method. When the first communication processor 522 receives the request for the first specific absorption rate information (YES in step S1420) from the application processor 510, the first communication processor 522 may transmit the time-based specific absorption rate according to the first wireless communication method to the application processor 510 in step S1430. This time-based specific absorption rate is calculated during a time section from a current time point to a predefined time point, and is transmitted to the application processor 510 as the first specific absorption rate information.

Referring to FIG. 12, the second wireless communication module 530 may include the second communication processor 532 and the second transceiver 534. The second communication processor 532 may include the second specific absorption rate management unit 536. The second specific absorption rate management unit 536 may transmit second specific absorption rate information to the application processor 510 in response to receiving a request for the second specific absorption rate information from the application processor 510. For example, the second specific absorption rate information may be transmitted to the application processor 510 in the same or similar method as the method described above with reference to FIG. 14.

As described with reference to FIG. 7, the application processor 510 may generate integrated specific absorption rate information based on the received first specific absorption rate information and/or second specific absorption rate information. As described with reference to FIG. 7 and FIG. 10, the application processor 510 may determine whether to adjust the transmission power of the first wireless communication method and/or the second wireless communication method based on the integrated specific absorption rate information. If the application processor 510 determines that the transmission power is to be controlled, then the application processor 510 may transmit a transmission power control request.

The flowcharts and the above description of FIGS. 7, 9 to 11, 13, and 14 are merely exemplary, but may be implemented differently in other embodiments. For example, according to other embodiments, the order of steps may be changed, a part of the steps may be performed repeatedly, a part of the steps may be added/changed/omitted, or the subject for performing the steps may be changed.

The processors described herein (e.g., the application processor 510, the communication processors 522, 532, 610, etc.) may be a hardware circuit, such as a microprocessor, a CPU (Central Processing Unit), a GPU (graphics processor), a digital signal processor (DSP), a field-programmable gate array (FPGA), etc., and may be part of a computer. The processors may be configured by software such that the processors are configured to perform different functions. As is understood, “software” may refer to prescribed rules to operate a computer, such as code or script.

What is claimed is:

1. An electronic device, comprising:
an application processor; and
at least one communication processor configured to generate first specific absorption rate information associated with electromagnetic waves generated by the electronic device according to a first wireless communication method, and second specific absorption rate information associated with electromagnetic waves generated by the electronic device according to a second wireless communication method,
wherein the application processor is configured to:
receive the first specific absorption rate information and the second specific absorption rate information from the at least one communication processor,
generate integrated specific absorption rate information, based on one or both of the first specific absorption rate information or the second specific absorption rate information,
determine whether to adjust a transmission power of the first wireless communication method or a transmission power of the second wireless communication method based on the integrated specific absorption rate information, and
transmit a transmission power control request to the at least one communication processor to adjust one or both of the transmission power of the first wireless communication method or the transmission power of the second wireless communication method based on a determination to adjust one or both of the transmission power of the first wireless communication method or the transmission power of the second wireless communication method.

2. The electronic device as claimed in claim 1, wherein the first specific absorption rate information comprises information on a time-based specific absorption rate according to the first wireless communication method,
wherein the second specific absorption rate information comprises information on a time-based specific absorption rate according to the second wireless communication method, and
wherein the integrated specific absorption rate information comprises information on an average specific absorption rate during a predefined time section according to at least one of the first specific absorption rate information according to the first wireless communication method or the second specific absorption rate information according to the second wireless communication method.

3. The electronic device as claimed in claim 1, wherein the at least one communication processor is further configured to:
calculate a time-based specific absorption rate by the first wireless communication method,
determine whether an average specific absorption rate according to the first wireless communication method during a first predefined time section to a current time point exceeds a threshold value, and
in response to determining that the average specific absorption rate according to the first wireless communication method exceeds the threshold value, transmit the first specific absorption rate information to the application processor, wherein the first specific absorption rate information comprises the time-based specific absorption rate according to the first wireless communication method.

4. The electronic device as claimed in claim 1, wherein the at least one communication processor is further configured to:
calculate a time-based specific absorption rate according to the first wireless communication method,
determine whether the time-based specific absorption rate according to the first wireless communication method at a current time point exceeds a threshold value, and
in response to determining that the time-based specific absorption rate according to the first wireless communication method exceeds the threshold value, transmit the first specific absorption rate information to the application processor, wherein the first specific absorption rate information comprises the time-based specific absorption rate according to the first wireless communication method.

5. The electronic device as claimed in claim 1, wherein the application processor is configured to:
transmit a request for the first specific absorption rate information to the at least one communication processor,
wherein the at least one communication processor is further configured to:
in response to receiving the request for the first specific absorption rate information from the application processor, transmit the first specific absorption rate information according to the first wireless communication method to the application processor.

6. The electronic device as claimed in claim 5, wherein the application processor is further configured to:
determine whether user data to be transmitted through the first wireless communication method is present at a current time point,
in response to determining that the user data to be transmitted through the first wireless communication method is present, determine whether traffic of the user data to be transmitted through the first wireless communication method is equal to or greater than a threshold value, and
in response to determining that the traffic of the user data is equal to or greater than the threshold value, transmit the request for the first specific absorption rate information to the at least one communication processor.

7. The electronic device as claimed in claim 1, wherein the transmission power control request comprises a request for controlling the transmission power of at least one of the first wireless communication method or the second wireless communication method.

8. The electronic device as claimed in claim 1, wherein the transmission power control request comprises a request for controlling the transmission power of the first wireless communication method, and
wherein the first wireless communication method has a higher specific absorption rate than the second wireless communication method.

9. The electronic device as claimed in claim 1, wherein the transmission power control request comprises a request for controlling the transmission power of one of the first wireless communication method or the second wireless communication method where user data for transmission is present at a current time point.

10. The electronic device as claimed in claim 1, wherein the transmission power control request comprises a request for controlling the transmission power of the first wireless communication method, and
wherein the application processor is further configured to:
determine whether user data to be transmitted through the first wireless communication method is present at a current time point, and
in response to determining that the user data to be transmitted through the first wireless communication method is not present, delay transmission of the transmission power control request.

11. The electronic device as claimed in claim 10, wherein the application processor is further configured to transmit the transmission power control request in response to determining that user data to be transmitted through the first wireless communication method is present.

12. The electronic device as claimed in claim 1, wherein the first wireless communication method comprises a Wireless Local Area Network (WLAN) communication, and the second wireless communication method comprises a Bluetooth communication.

13. The electronic device as claimed in claim 1, wherein the application processor is further configured to:
determine a target transmission power based on a determination to adjust the transmission power of the first wireless communication method or the second wireless communication method, and
transmit the transmission power control request comprising the target transmission power to the at least one communication processor.

14. The electronic device as claimed in claim 13, wherein the at least one communication processor is further configured to:
in response to receiving the transmission power control request, adjust the transmission power of at least one of the first wireless communication method or the second wireless communication method to the target transmission power.

15. An electronic device, comprising:
a memory; and
at least one application processor electrically connected to the memory and configured to execute at least one computer-readable program included in the memory,
wherein the at least one computer-readable program comprises instructions to:
receive first specific absorption rate information associated with electromagnetic waves generated by the electronic device according to a first wireless communication method and second specific absorption rate information associated with electromagnetic waves generated by the electronic device according to a second wireless communication method from at least one communication processor communicable with the application processor,
generate integrated specific absorption rate information based on one or both of the first specific absorption rate information or the second specific absorption rate information,
determine whether to adjust a transmission power of the first wireless communication method or a transmission power of the second wireless communication method based on the integrated specific absorption rate information, and
transmit a transmission power control request to the at least one communication processor to adjust one or both of the transmission power of the first wireless communication method or the transmission power of the second wireless communication method based on a determination to adjust one or both of the transmission power of the first wireless communication method or the transmission power of the second wireless communication method.

16. The electronic device as claimed in claim 15, wherein the at least one computer-readable program further comprises instructions to:
determine whether user data to be transmitted through the first wireless communication method is present at a current time point,
in response to determining that the user data to be transmitted through the first wireless communication method is present, determine whether traffic of the user data to be transmitted through the first wireless communication method is equal to or greater than a threshold value, and
in response to determining that the traffic of the user data is equal to or greater than the threshold value, transmit a request for the first specific absorption rate information to the at least one communication processor.

17. The electronic device as claimed in claim 15, wherein the transmission power control request comprises a request for controlling the transmission power of the first wireless communication method, and
wherein the at least one computer-readable program further comprises instructions to:
determine whether user data to be transmitted through the first wireless communication method is present at a current time point, and
in response to determining that the user data to be transmitted through the first wireless communication method is not present, delay transmission of the transmission power control request.

18. The electronic device as claimed in claim 17, wherein the at least one computer-readable program further comprises instructions to transmit the transmission power control request in response to determining that the user data transmitted through the first wireless communication method is present.

19. The electronic device as claimed in claim 15, wherein the first specific absorption rate information comprises information on a time-based specific absorption rate according to the first wireless communication method,
wherein the second specific absorption rate information comprises information on a time-based specific absorption rate according to the second wireless communication method, and
wherein the integrated specific absorption rate information comprises information on an average specific absorption rate during a predefined time section according to at least one of the first specific absorption rate information according to the first wireless communication method or the second specific absorption rate information according to the second wireless communication method.

20. An electronic device, comprising:
a memory; and
at least one communication processor electrically connected to the memory, and configured to execute at least one computer-readable program included in the memory,
wherein the at least one computer-readable program is configured to:
calculate a time-based specific absorption rate according to a wireless communication method,
determine whether the time-based specific absorption rate according to the wireless communication method exceeds a threshold value, and
in response to determining that the time-based specific absorption rate according to the wireless communication method exceeds the threshold value, transmit information related to the time-based specific absorption rate according to the wireless communication method to an application processor that is configured to communicate with the at least one communication processor.
